(19) United States
(12) Patent Application Publication
(10) Pub. No.: US 2007/0042665 A1
(43) Pub. Date: Feb. 22, 2007

(54) Micro-porous non-woven fabric and fabricating method thereof

(76) Inventors: Chao-Chun Peng, Hsinchu City (TW); Po-Hsiung Huang, Taipei City (TW)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/318,903

(22) Filed: Dec. 21, 2005

(30) Foreign Application Priority Data
Aug. 22, 2005 (TW) 94128634

(51) Int. Cl. D04H 1/56; B32B 5/16; B32B 5/26

(52) U.S. Cl. 442/389; 442/400; 442/417; 442/393

(57) ABSTRACT

The present invention relates to a method for making a micro-porous non-woven fabric, which comprises melt-blown fibers, functional particulates and low-melting point fibers. The low-melting point fibers are used to increase porosity of the non-woven fabric to enhance air permeability. The melt-blown fibers are tacky to improve the strength of adhesion between the melt-blown fibers and the functional particulates.

### RELATED APPLICATIONS

The present application is based on, and claims priority from, Taiwan Application Serial No. 94128634, filed Aug. 22, 2005, the disclosure of which is hereby incorporated by reference herein in its entirety.

### BACKGROUND

1. Field of Invention

The present invention relates to an adsorptive material and a fabricating method thereof. More particularly, the present invention relates to a micro-porous non-woven fabric and a fabricating method thereof.

2. Description of Related Art

A conventional method of fabricating a functional non-woven fabric having short-cut fibers and functional particulates is usually performed in a melt-blown system. First, a thermoplastic material is melted and then squeezed into one or more spinning plates with high-speed airflow to form an airflow carrying melted fibers. Then, the melted fibers are deposited on a web to form a non-woven fabric. The functional particulates, such as active carbon, are used in treating gases and liquids, recycling chemical contaminants, eliminating chemical contaminants and adsorbing volatile organic odor in medical fields. Thus, for these uses, a method of producing the non-woven fabric having the functional particulates is provided, wherein the functional particulate is added into a fibrous matrix.

A thermosetting adhesive is used to improve the adhesion between functional particulates and fibers in a conventional functional non-woven fabric. In U.S. Pat. No. 5,281,437, a process of loading the functional particulate into a fibrous matrix by airflow is described. Because of restrictions on the structure of the fibrous matrix, adhesion strength between functional particulates and short-cut fibers is too weak to be adhered. Thus, the thermosetting adhesive is required to enhance the adhesion strength between the functional particulates and the short-cut fibers. However, a large amount of the functional particulates are lost when the functional particulates are loaded into the fibrous matrix.

In U.S. Pat. No. 5,569,489, a method of making a non-woven fabric is described, which uses airflow to mix functional particulates and fibers. The mixture in the airflow is deposited on a web to form a non-woven fabric. However, an adhesive is also needed to enhance adhesion strength between the functional particulates and the fibers, and many functional particulates are still lost.

In U.S. Pat. No. 6,703,072, composite air nozzles are utilized to mix functional particulates and short-cut fibers. The problem of the conventional method is that adhesion strength between the functional particulates and the short-cut fibers is still too weak to be well adhered, so an adhesive is still needed.

However, the trouble with using an adhesive in a non-woven fabric is that the functional particulates are covered with the thermosetting adhesive. Consequently, adsorption ability of the functional particulates and air permeability of the non-woven fabric are reduced. Therefore, a process of making a micro-porous non-woven fabric is required to solve the problems mentioned above.

### SUMMARY

In one aspect, this present invention provides a one-step method of fabricating a micro-porous non-woven fabric that has high air permeability, low pressure loss and high adsorption ability.

In another aspect, this present invention provides a method of fabricating a micro-porous non-woven fabric that provides good adhesion between fibers and functional particulates. Even if a thermosetting adhesive is absent, functional particulates and fibers can be adhered firmly to melt-blown fibers by using the sticky melt-blown fibers. The functional particulates and the fibers are adhered further firmly because of the subsequent heating treatment.

In accordance with the foregoing and other aspects of the present invention, the present invention provides a method of fabricating a non-woven fabric to enhance adhesion strength between fibers and functional particulates. Other low-melting point fibers are loaded by using a conventional method of is making a functional non-woven fabric. First, short-cut fibers are melted in a melt-blown system. After that, the melted short-cut fibers are blown to form melt-blown fiber airflow from the melt-blown system. The melt-blown fibers blown from the melt-blown system are sticky. The low-melting point fibers carried by airflow are sprayed into the melt-blown fiber airflow at an angle to form a first composite airflow. After that, the functional particulates are sprayed into the first composite airflow to form a second composite airflow. Thus, the functional particulates and the low-melting point fibers are adhered to the melt-blown fibers, and the second composite airflow is deposited on a suction device to form a functional non-woven.

According to one embodiment of the present invention, the melt point of the low-melting point fibers is about 80° C. Voids of the melt-blown fibers can be expanded by the low-melting point fibers to increase air permeability of the non-woven fabric. Moreover, the functional particulates are adhered firmly to the fibers to enhance adhesion strength of the functional particulates by a subsequent heat treatment.

In accordance with the foregoing and other aspects of the present invention, the present invention provides a non-woven fabric that is a tri-layer structure. A first layer is a melt-blown fiber layer, which is formed by depositing airflow of melt-blown fibers on a suction device. A second layer is a functional particulate layer, which is formed by depositing composite fibers on the melt-blown fiber layer. A third layer is a melt-blown fiber layer, which is positioned on the functional particulate layer. The non-woven fabric is a tri-layer structure that is produced by a one-step method without thermosetting adhesives so adhesion strength between the functional particulates and the fibers are improved.

Thus, a micro-porous non-woven fabricated according to the present invention has good adhesion strength between functional particulates and fibers. Low-melting point fibers are used to increase air permeability of the non-woven fabric according to one embodiment of the present invention. Moreover, the melt-blown fibers are sticky and are used to enhance the adhesion strength between functional particulates and fibers. Furthermore, the method of the present invention is a one-step method. Besides, the angle at which the functional particulates are sprayed into the melt-blown fibers can be adjusted to decrease the loss of the functional particulates. The subsequent heat treatment is performed to enhance adhesion strength between the functional particulates and the fibers, and to improve air permeability of the non-woven fabric further.

### BRIEF DESCRIPTION OF THE DRAWINGS

The invention can be more fully understood by reading the following detailed description of the preferred embodiment, with reference made to the accompanying drawings as follows:

FIG. 1 is a schematic diagram showing a process of fabricating a micro-porous non-woven fabric according to one embodiment of the present invention.

FIG. 2 is a SEM image showing a non-woven fabric that is a tri-layer structure according to one embodiment of the present invention.

FIG. 3 is a schematic diagram showing the non-woven fabric according to FIG. 2.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to one embodiment of the present invention, low-melting point fibers are loaded by using a conventional method of making a functional non-woven to enhance air permeability of the non-woven fabric.

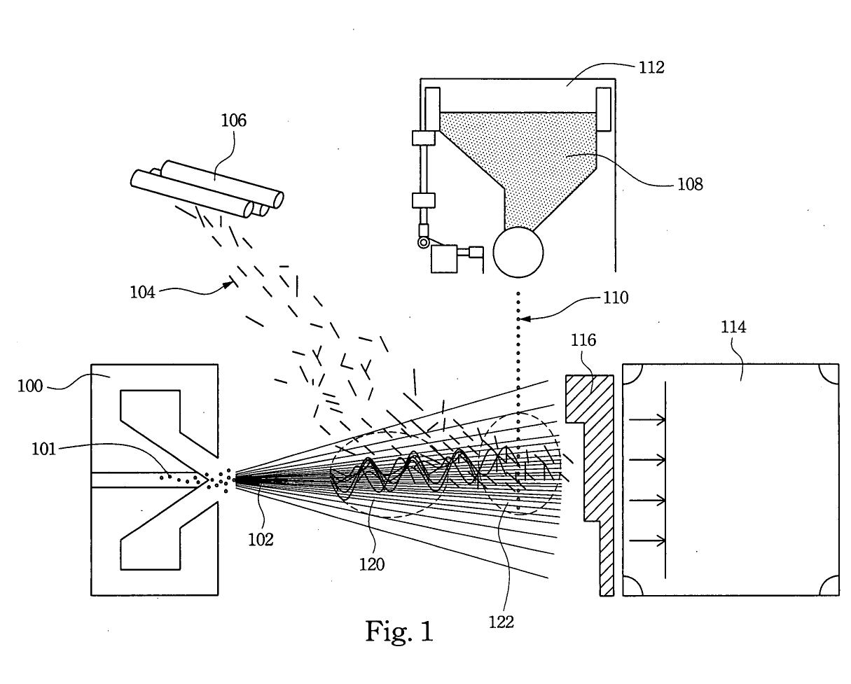

FIG. 1 is a schematic diagram showing a process of fabricating a micro-porous non-woven fabric according to one embodiment of the present invention. In FIG. 1, short-cut fibers, such as polypropylene, polyester, polyethylene, ethylene copolymer, polyurethane elastomer or nylon, are melted in a melt-blown system 100 to form melt-blown fibers 101. After that, melt-blown fibers 101 are squeezed through spinning plates of the melt-blown system 100 to form a melt-blown fiber airflow 102. The melt-blown fiber airflow 102 sprayed from the melt-blown system 100 is sticky. The melt-blown fiber airflow 102 mentioned above is sprayed in a fan-shape, and distribution of the melt-blown fibers in the center of the melt-blown fiber airflow 102 is denser than at the two sides of the melt-blown fiber airflow 102.

Simultaneously, low-melting point fibers 106 are carried by airflow to form a low-melting point fiber airflow 104. The low-melting point fiber airflow 104 is sprayed into the melt-blown fiber airflow 102 at an angle to compose a first composite airflow 120. After that, functional particulates 108 are sprayed from a spraying device 112 to form a functional particulate airflow 110. The density of the functional particulates 108 is greater than the low-melting point fibers 106 and the melt-blown fibers 101, so the greater part of the functional particulates 108 are sprayed into the first composite airflow 120 having denser distribution to compose a second composite airflow 122. Thus, the low-melting point fibers 106 and the functional particulates 108 are simultaneously sprayed into the center of the melt-blown fiber airflow 102 having denser distribution, which are adhered to the melt-blown fibers of the melt-blown fiber airflow 102 instantly. Then, the second composite airflow 122 is deposited on a suction device 114 to form a non-woven fabric 116.

Preferably, materials of the functional particulates 108 are active carbon, alumina impregnated in potassium permanganate, or super-adsorptive polymer. According to one embodiment of the invention, the functional particulates 108 are sprayed vertically from a spraying device 112 into the melt-blown fiber airflow 102. However, the present invention can also use other spray angles to spray the functional particulates 108 into the melt-blown fiber airflow 102. The spray angles can be adjusted to prevent the functional particulates 108 from being lost according to the demands.

The melt point of the low-melting point fibers 106 is about 80° C. The low-melting point fibers 106 are low-melting sheath-core composite fibers, wherein the melt point of the sheath fibers are lower than the core fibers. The materials of the low-melting sheath-core composite fibers are preferably polyethylene and polypropylene, polyethylene, or polyethylene teraphthalate; and more preferably, polyethylene and polypropylene, or polyethylene and polyethylene teraphthalate. Moreover, the melt points of the sheath-core composite fibers mentioned above are preferably 128° C. and 163° C., or 128° C. and 254° C.

The diameter of the low-melting point fibers 106 is about 10 μm, which is larger than the melt-blown fibers 101 of about 1 μm, so that voids of the melt-blown fibers 101 can be expanded by the low-melting point fibers 106 to increase air permeability of the non-woven fabric. Moreover, the melt-blown fibers 101 are melted by a subsequent heat treatment to improve air permeability of the non-woven fabric further. The low-melting point fibers 106 are also melted by the heat treatment to adhere the functional particulates firmly to the fibers to enhance adhesion strength between the functional particulates and the fibers.

The melt-blown system 100 and the suction device 114 are placed horizontally according to one embodiment of the invention. The suction device 114 mentioned above is performed clockwise. According to one embodiment of the invention, the low-melting point fibers 106 are joined to the melt-blown airflow 102 in front of the functional particulates 108. However, the position at which the melt-blown airflow 102 of the low-melting point fibers 106 joins the functional particulates 108 can be exchanged.

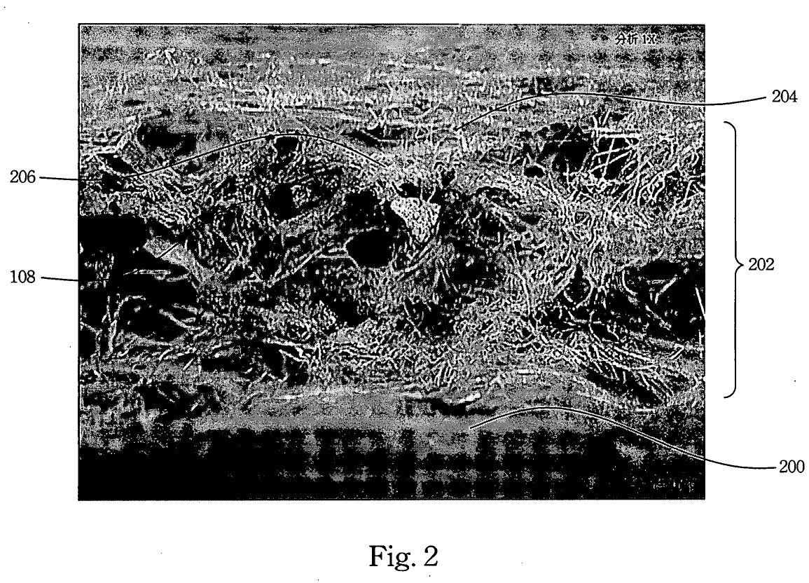

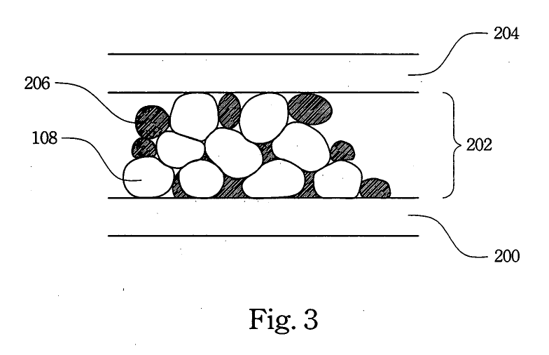

FIG. 2 is a SEM image showing a non-woven fabric that is a tri-layer structure according to one embodiment of the present invention. FIG. 3 is a schematic diagram showing the non-woven fabric according to FIG. 2. The micro-porous non-woven fabric is a three-part coating that is produced by a one-step method. A first layer is a melt-blown fiber layer 200, deposited by the melt-blown fiber airflow 102 on the suction device 112. After the functional particulates 108 and the low-melting point fibers 106 are adhered to the melt-blown fiber airflow 102 that is sticky, a second functional layer 202 is formed on the melt-blown fiber layer 200. The particle size of the functional particulates 108 are larger than the composite fibers 206 that are composed of the melt-blown fibers 101 and the low-melting point fibers 106. A third layer is a melt-blown fiber layer 204. The material of the melt-blown fiber layer 204 is preferably made of the melt-blown fibers 101 and further a few of the low-melting point fibers 106 and the functional particulates 108. The distribution of the melt-blown fibers 101 in center of the melt-blown fiber airflow 102 is denser than the distribution of the melt-blown fibers 101 at the two sides of the melt-blown fiber airflow 102, so the tri-layer structure can be produced by a one-step method without adding thermosetting adhesive enhance the adhesion strength between the fibers and the functional particulates.

Adsorption Test and Pressure Drop Test

An adsorption test and pressure drop test were performed on the non-woven fabric that was produced by the method according to one embodiment of the invention. The materials of the melt-blown fibers, low-melting point fibers and functional particulates were respectively polypropylene, composite fibers of polyethylene and polypropylene, and active carbon. The following table describes six embodiments of the invention using different weight and particle size of the functional particulates of the non-woven fabric.

| | | | | Adsorptive | |
|---|---|---|---|---|---|
| | | | | weight | |
| | | Weight of | Weight | percent | |
| | Diameter | the non- | percent | of carbon | Pressure |
| | of active | woven | of active | tetra- | drop |
| | carbon | fabric | carbon | chloride | (mm |
| Sample | (mesh) | (g/m²) | (%) | (%) | H₂O) |
| Original | — | 24.40 | 0 | 0 | 2.4 |
| non-woven | | | | | |
| fabric | | | | | |
| 1 | 12 | 1518.76 | 98.39 | 22.85 | 1.7 |
| 2 | 20 × 40 | 770.28 | 96.83 | 28.39 | 1.0 |
| 3 | 30 × 60 | 364.24 | 93.30 | 56.85 | 1.8 |
| 4 | 30 × 60 | 387.84 | 93.71 | 55.31 | 1.4 |
| 5 | 30 × 60 | 544.20 | 95.52 | 59.43 | 1.7 |
| 6 | 30 × 60 | 352.96 | 93.09 | 54.13 | 1.7 |

The test method of the present invention is according to the adsorptive test of carbon tetrachloride of the American Society for Testing and Materials (ASTM). The result of the adsorption effect shown above shows that the non-woven fabric produced by one embodiment of the invention has good adsorption effect, which is higher than the original non-woven fabric according to the adsorptive weight percent of carbon tetrachloride.

The pressure drop test is performed by utilizing 32 liter/min of steady gas flow passing through the non-woven fabric. Then, the amount of gas flowing out is obtained and the pressure drop of the non-woven fabric can be calculated. Thus, the result of the pressure drop shown above shows that the non-woven fabric produced by one embodiment of the invention has great air permeability, which is lower than the original non-woven fabric.

Thus, a micro-porous non-woven fabric made according to the present invention has good adhesion strength between functional particulates and fibers. Low-melting point fibers are used to increase air permeability of the non-woven fabric according to one embodiment of the present invention. Moreover, the melt-blown fibers are sticky and are used to enhance the adhesion strength between functional particulates and fibers. Furthermore, the method of the present invention is a one-step method. Besides, the angle at which the functional particulates are sprayed into the melt-blown fibers can be adjusted to decrease loss of the functional particulates. The subsequent heat treatment is performed to enhance adhesion strength between the functional particulates and the fibers, and to improve air permeability of the non-woven fabric further.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A micro-porous non-woven fabric, the micro-porous non-woven fabric comprising:
a melt-blown fiber layer comprising melt-blown fibers;
a functional particulate layer positioned on the melt-blown fiber layer, wherein the functional particulate layer comprises a plurality of functional particulates and low-melting point fibers; and
a melt-blown fiber layer positioned on the functional particulate layer, wherein the melt-blown fiber layer comprises the melt-blown fibers.

2. The micro-porous non-woven fabric of claim 1, wherein the melt-blown fibers comprise polypropylene, polyester, polyethylene, ethylene copolymer, polyurethane elastomer or nylon.

3. The micro-porous non-woven fabric of claim 1, wherein the melting point of the low-melting point fibers is about 80° C.

4. The micro-porous non-woven fabric of claim 3, wherein the low-melting point fibers are low-melting sheath-core composite fibers.

5. The micro-porous non-woven fabric of claim 4, wherein materials of the low-melting sheath-core composite fibers are selected from the group of polyethylene, polypropylene, polyethylene and polyethylene teraphthalate.

6. The micro-porous non-woven fabric of claim 1, wherein the functional particulates comprise active carbon, alumina impregnated in potassium permanganate, or super-adsorptive polymer.

7. The micro-porous non-woven fabric of claim 1, wherein the functional particulate layer further comprises the melt-blown fibers, and the melt-blown fibers and the low-melting point fibers form composite fibers.

8. The micro-porous non-woven fabric of claim 1, wherein the melt-blown fibers layer further comprises the low-melting point fibers and the functional particulates.

9. A method of making a functional non-woven fabric, the method comprising:
melting melt-blown fibers;
blowing the melt-blown fibers to form a melt-blown fiber airflow;
spraying a low-melting point fiber airflow into the melt-blown fiber airflow, the low-melting fiber airflow joining the melt-blown fiber airflow at an angle to compose a first composite airflow;
spraying functional particulates into the melt-blown fiber airflow to compose a second composite airflow;
depositing the second composite airflow on a substrate; and
cooling the melt-blown fibers, low-melting point fibers and the functional particulates of the second composite airflow to form a non-woven fabric in which the functional particulates are fixed.

10. A method of making a functional non-woven fabric of claim 9, wherein the distribution of the melt-blown fibers in the center of the melt-blown fiber airflow is denser than the distribution of the melt-blown fibers at the two sides of the melt-blown fiber airflow.

11. A method of making a functional non-woven fabric of claim 9, wherein the melt-blown fibers comprise polypropylene, polyester, polyethylene, ethylene copolymer, polyurethane elastomer or nylon.

12. A method of making a functional non-woven fabric of claim 9, wherein the melting point of the low-melting point fibers is about 80° C.

13. A method of making a functional non-woven fabric of claim 9, wherein the low-melting point fibers are low-melting sheath-core composite fibers.

14. A method of making a functional non-woven fabric of claim 13, wherein materials of the low-melting sheath-core composite fibers are selected from the group of polyethylene and polypropylene, polyethylene and poly ethylene terephthalate.

15. A method of making a functional non-woven fabric of claim 9, wherein the functional particulates comprise active carbon, alumina impregnated in potassium permanganate, or super-adsorptive polymer.

16. A method of making a functional non-woven fabric of claim 9, wherein the functional particulates are sprayed vertically into the melt-blown fiber airflow.

17. A method of making a functional non-woven fabric of claim 9, further comprising performing a heat treatment process after forming the non-woven fabric to melt the low-melting point fibers and the melt-blown fibers to enhance adhesion strength between the functional particulates and the fibers and to improve air permeability of the non-woven fabric.
